(19) United States
(12) Patent Application Publication
(10) Pub. No.: US 2013/0337308 A1
(43) Pub. Date: Dec. 19, 2013

(54) HOUSING FOR RECEIVING AT LEAST ONE BATTERY CELL, CONTACTING DEVICE, BATTERY SYSTEM AND VEHICLE

(71) Applicant: GM Global Technology Operations LLC, Detroit, MI (US)

(72) Inventor: Ralf RATHMACHER, Schmitten im Taunus (DE)

(21) Appl. No.: 13/919,837

(22) Filed: Jun. 17, 2013

(30) Foreign Application Priority Data
Jun. 19, 2012 (DE) 10 2012 012 154.7

(51) Int. Cl. H01M 2/10

(52) U.S. Cl. CPC H01M 2/10
USPC 429/100

(57) ABSTRACT

A housing is provided for holding a battery cell, in particular for holding a vehicle battery, with a battery holding space in the form of the battery cell to be received therein, with a contact area, which is arranged on the housing at a location at which, as intended, for a battery cell arranged in the battery holding space, contact connections for this battery cell are arranged, and which is configured such that when the contacting area is actuated with a contacting device, an electric contact through the housing can be established between at least two of the contact connections of the at least one battery cell.

### CROSS-REFERENCE TO RELATED APPLICATION

This application claims priority to German Patent Application No. 10 2012 012 154.7, filed Jun. 19, 2012, which is incorporated herein by reference in its entirety.

### TECHNICAL FIELD

The technical field relates to a housing for receiving at least one battery cell, in particular a vehicle battery. The technical filed further relates to a contacting device, a battery system and a vehicle comprising the housing and the contacting device.

### BACKGROUND

Motor vehicles, such as electric vehicles and hybrid vehicles based on an electric drive comprise a drive in form of a battery. Frequently this means the use of batteries having a plurality of battery cells. These batteries are called traction batteries. A so-called traction battery (also called drive battery or cycle battery) is understood to be a group of interconnected individual battery cells or battery blocks for driving electrically driven vehicles.

Such a traction battery has been described in the DE 10 2010 045 904 A1. The traction battery comprises a housing containing several batteries that are connected in series. These battery cells have a positive terminal and a negative terminal The positive terminal has a fuse connected to it which interrupts the current path via the positive terminal in case a certain wattage is exceeded. The other end of the fuse and the negative terminal has a main contactor connected to them, respectively. Between the end of the fuse connected to the respective main contactor and the negative terminal there is a switch by means which the battery cells can be short-circuited via the fuse.

Against this background the present invention is based on the requirement to provide a housing for receiving at least one battery cell, which permits improved discharging of the battery cell. Other objects, desirable features and characteristics will become apparent from the subsequent summary and detailed description, and the appended claims, taken in conjunction with the accompanying drawings and this background.

### SUMMARY

A housing is provided for holding at least one battery cell, in particular for holding a vehicle battery, with a battery-holding space shaped in the form of the battery cell for holding the same, with at least one contacting area provided on the housing at a location at which, as intended, for a battery cell arranged in the battery holding space, contact connections for this battery cell are arranged, and which is configured such that when the contacting area is actuated by means of a contacting device, an electrical contact through the housing can be established between at least two of the contact connections of the at least one battery cell.

A contacting device for use with the housing according to an embodiment with at least two contact elements is configured to electrically contact at least one positive contact connection and a negative contact connection of a battery cell arranged in the battery holding space of the housing. The contact elements are configured to electrically contact the contact connections through the contacting area of the housing.

A battery system with a housing according to an embodiment, with at least one battery cell is arranged in the battery holding space of the housing.

A motor vehicle, with a housing according to an embodiment is provided in the motor vehicle, with at least one battery cell arranged in the housing and with a contacting device according to an embodiment.

The idea on which the embodiments are at least partially based is that the housing is provided with a contacting area that is arranged and configured so that it can actuate the contacting area with a contacting device. With the contacting area of the housing in the area, in which the contact connections of the battery cell are arranged, and by actuating the contacting area with a contacting device, it is very easy to establish an electrical contact through the housing between at least two of the contact connections of the at least one battery cell. In this way the at least one battery cell can be discharged in a very simple manner without first having to remove the battery cell or to arrange for it to be discharged by specially trained and equipped personnel.

In embodiments the contacting area comprises at least two predetermined breaking points. Each of the predetermined breaking points is arranged on the housing at a location, at which contact connections of a battery cell are arranged, as intended, for the battery cell arranged in the battery holding space. It is very simple and cost-effective to form such predetermined breaking points in the housing. In order to provide the contacting areas configured as predetermined breaking points in the housing, the housing may, for example, be manufactured from plastic and/or metal.

In embodiments the contacting area may comprise at least two repeatedly mechanically operable contact arranging devices.

In further embodiments arranging devices are provided that comprise at least one mechanical guide. A mechanical guide may, for example, be configured to guide the contacting device for actuating the contacting area. In this way, connecting the contact connections with the contacting device can be additionally simplified for a user due to the mechanical guide of the contact arranging device.

The predetermined breaking point and/or the contact arranging device, according to embodiments, comprises at least one locking device that is configured to protect the contacting area against actuation when in a non-actuated state, and to permit actuation of the contacting area when in an actuated state.

In embodiments, the contacting device is provided as a one-part, preferably one-piece contacting device. The contacting device is made of an electrically resistive material. Alternatively it is feasible to configure the contacting device as a multipart device.

The contact elements of the contacting device, according to embodiments, are configured as metallic contact elements, which are coupled to each other by means of an electrically resistive coupling element. The connecting element is preferably composed of an electrical resistance that is connected with the contact elements in an electrically conductive manner.

In embodiments the contacting device comprises an electrically insulated gripping surface. This represents a manner of protecting the user of the contacting device.

In further embodiments the contacting device is U-shaped and the contact elements are respectively arranged at one end of the U-shape. The U-shaped contacting device may be connected in a very easy manner also with associated contact connections of the at least one battery cell. The two ends of the contact elements of the contacting device serve to simultaneously open the associated predetermined breaking points by pressing on them.

In embodiments the contacting device and the housing are arranged in the vehicle in such a way that the contact elements of the contacting device, in case of mechanical deformation of the vehicle, automatically electrically contact the at least one positive contact connection and the at least one negative contact connection of a battery cell arranged in the battery-holding space of the housing. In this way the battery cell is automatically discharged in case of an accident. To this end the contacting device with its contact elements and the associated contact connections of the battery cell and the contacting area of the housing are arranged relative to each in such a way that for example in case of a frontal crash, a rear crash and/or a lateral crash, the contacting device with its contact elements is moved through the contacting area of the housing and is connected, in particular electrically connected, with the associated contact connections. Additionally or alternatively, for example in case of a frontal crash, a rear crash and/or a lateral crash, the housing may be moved contrary to the contacting device and its contact elements, such that the contact connections of the at least one battery cell received in the housing is connected, in particular electrically connected, with the associated contact elements of the contacting device.

In further embodiments a triggering device is provided which, in case of detecting an imminent accident and/or in case of an accident that has already taken place, moves the contacting device such that the contact elements of the contacting device electrically contact the at least one positive contact connection or the at least one negative contact connection of a battery cell arranged in the battery-holding space of the housing. This allows the battery system to be automatically discharged in case of an accident.

The above implementations and further developments, insofar as meaningful, can be combined randomly with each other. Further possible designs, further developments and implementations of the invention also comprise not explicitly mentioned combinations of characteristics of the embodiments, described previously or in the following with reference to the embodiments. In particular, the expert may add individual aspects as improvements to the respective basic form.

### BRIEF DESCRIPTION OF THE DRAWING

The present invention will hereinafter be described in conjunction with the following drawing figure, wherein like numerals denote like elements, and:

FIG. 1 shows a principal sketch of a housing with a battery cell of a battery system and a contacting device according to one embodiment

### DETAILED DESCRIPTION

The following detailed description is merely exemplary in nature and is not intended to limit application and uses. Furthermore, there is no intention to be bound by any theory presented in the preceding background, summary, or the following detailed description.

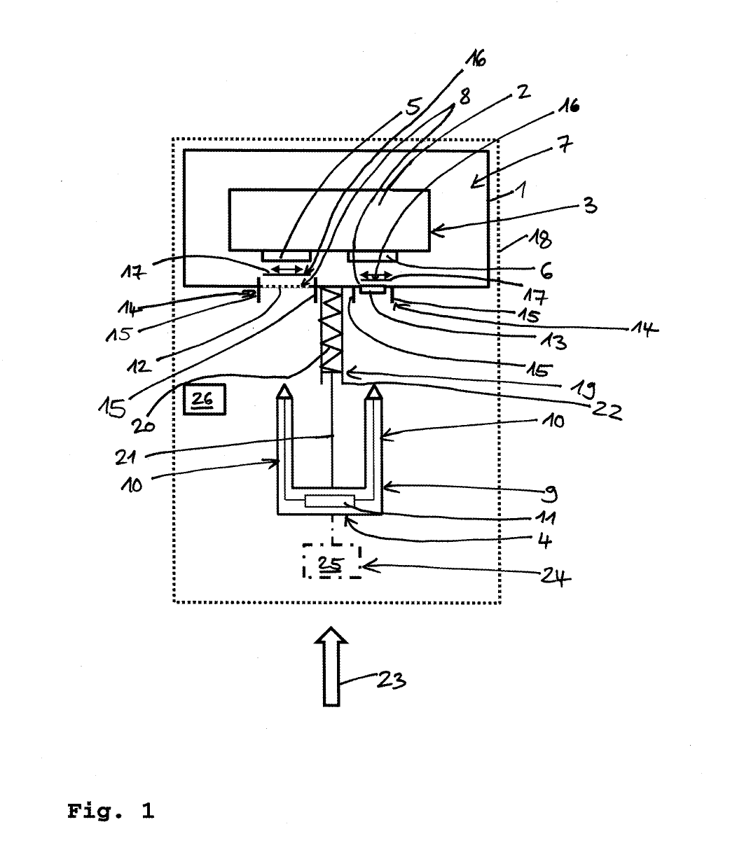

FIG. 1 shows a principal sketch of a housing 1 with at least one battery cell 2 received therein of a battery system 3 and a contacting device 9 according to one embodiment. The battery cell 2 comprises contact connections, in particular at least one positive and one negative contact connection 5, 6, such as at least one positive and one negative high-voltage (HV) connection in the case of a high-voltage (HV) battery as the battery system.

Vehicles, such as electric vehicles or hybrid vehicles comprise a battery system for the drive with one or more battery cells. If such a vehicle is involved in an accident and the battery system is damaged, there is a latent danger from the not completely discharged battery system. This may become evident even with a distinct time delay.

Up to now a vehicle battery had to be removed following an accident or at least be discharged at great expense by specialized personnel.

According to one embodiment the housing 1 is therefore provided for receiving at least one battery cell 2, for example, a vehicle battery 3. The housing 1 comprises a battery holder or a battery holding space 7 for receiving the at least one battery cell 2 of an associated battery system 3. Herein the housing 1 encompasses a contacting area 8 which is provided in the area of, or opposite the contact connections 5, 6 of the at least one battery cell 2, when the battery cell 2 is held in the housing 1.

The contacting area 8 is configured to be actuable in that a contacting device 9 can be passed through the contacting area 8 and electrically connected with an associated positive and negative contact connection 5, 6 such that a discharge current flows. This ensures that the contacting device 9 connecting the positive and negative contact connection 5, 6 of the battery cell 2 is effective in discharging the at least one battery cell 2 of the battery system 3 without the battery system 3 having to be removed from the housing 1 or having to be discharged by specialist personnel.

The contacting device 9 is, for example, U-shaped and comprises two contact elements 10 in the embodiment shown in FIG. 1. The contact elements 10 each form an arm of the U-shaped contacting device 9, and they are connected with each other via a connecting element 4. Further, the contacting device 9 comprises a suitable ohmic resistance for preferably limiting the discharge current. The contacting device 9 may for example be a one-part or multipart device and may consist of metal or a metal alloy or may include the same. Furthermore the contacting device 9 may be optionally additionally insulated against the outside and comprise at least a grip section with a suitable insulation. For example, the two contact elements 10 may consist of metal or a metal alloy and be connected with a grip made of an insulation material or comprising an insulation layer, which is provided with a suitable electric resistance electrically conductively connected with the two contact elements 10.

The contacting device 9 in the embodiment in FIG. 1 is provided with a predetermined electric resistance 11 which is electrically conductively connected with the two contact elements 10. The resistance 11 is chosen such that the battery system 3 can be discharged at maximum speed without generating excessive heat or so that heat generation is limited.

The contacting area 8 of the housing 1 may, for example, comprise at least one predetermined breaking point 12 and a hinged flap 13, e.g. a rubber lip, as shown in the embodiment in FIG. 1. Or two predetermined breaking points 12 may for example be provided which can be broken with the contacting device 9 and its two contact elements 10, in order to electrically connect the contact elements 10 with the contact connections 5, 6 of the battery cell 2 behind them and to cause a discharge current to flow. The hinged flap 13, such as a rubber lip or a plastic flap with a film hinge, has the advantage, as an example, for a mechanically actuable contact arranging unit 14, that following removal of the contacting device 9, is will swing back into a closed position, in which access to the respective contact connection 5, 6 of the battery cell 2 is locked.

With this arrangement an additional guide rail 15 may be optionally provided on the housing 1 as a mechanical guide, e.g., a guide rail 15, on one or on both sides of the predetermined breaking point 12 and/or the contact arranging unit 14 such as the rubber lip 13, for guiding the contact elements 10 through the housing 1 and the contact arranging unit 14 to the contact connections 5, 6 of the at least one battery cell 2 of battery system 3.

Furthermore, an additional locking device 16 may be optionally provided which in a non-actuated state of the contacting area 8, i.e., the predetermined breaking point 12 and the rubber lip 13 in FIG. 1, for example, protects the same against actuation and in an actuated state permit actuation of the contacting area 8. The locking device 16 may, for example, be configured as at least one or two sliding elements 17, which can be pushed in front of the predetermined breaking point 12 or the rubber lip 13 and cover or lock the same, thereby preventing the contacting device 9 from opening the predetermined breaking point 12 and passing through the rubber lip 13. In order to electrically connect the contacting device 9 with the contact connections 5, 6 of battery cell 2, the sliding elements 17 are moved into an unlocked position, in which they have been removed from the predetermined breaking point 12 and the rubber lip 13, so that the predetermined breaking point 12 and the rubber lip 13 are exposed to the contacting device 9. The locking device 16 may, for example, be controlled via a control unit 26 of the vehicle 18, for example based on a signal of an airbag and for example be operated by means of at least one motor (not shown) or at least one other actuating unit, in order to move the locking device 16 from its locked position into an unlocked position, if an accident is recorded by triggering an airbag. The invention is not limited to this locking device. Any other kind of locking device may be provided for locking and unlocking the contacting area.

The predetermined breaking point 12 and the rubber lip 13 can be provided inside the housing 1, for example at a location not readily accessible to the customer without certain measures, according to requirement. Furthermore the respective predetermined breaking point 12 may be configured such that the housing is opened when pressing on it with a certain force, or an opening is formed which permits the contact element 10 of the contacting device 9 to pass through. The respective predetermined breaking point 12 may, for example, be arranged in the underbody of the housing 1, on the housing 1 behind clipped cladding or on the housing 1 below a rear vehicle seat. Behind the predetermined breaking point 12 and the rubber lip 13 in FIG. 1 there are the respective contact connections 5, 6 of the battery cell 2, e.g. a positive and a negative high-voltage (HV) connection of a battery cell of a high-voltage battery. If the contacting device 9 is pressed in further, the positive and negative battery connections 5, 6 are connected via the contacting device 9 allowing a discharge current to flow.

During vehicle operation the contacting device 9 is, for example, situated on the vehicle 18 at a location not readily accessible but indicated on the rescue card, preferably in the area of the predetermined breaking point 12 and the rubber lip 13 on the battery system 3. The housing 1 and the contacting device 9 have the advantage that a battery system 3, in particular a motor vehicle battery, may be discharged in terms of safety precautions soon after the accident by any present first-aiders, such as the fire brigade. In this way the potential danger from damaged, but not discharged batteries is reduced.

In a further embodiment a coupling device 19 may be additionally optionally provided, with which the housing 1 and the battery system 3 received therein can be coupled with the contacting device 9 in case of, for example, an accident in order to provide automatic discharging of the battery system 3. In the embodiment shown in FIG. 1 the coupling device 19 is a piston arrangement with a spring element 20. A piston 21 is connected with the contacting device 9, and a piston cylinder 22, for example, is connected with the housing 1. In case the vehicle is involved in an accident, in which a force is acting in direction of arrow 23 as indicated in the embodiment of FIG. 1, the contacting device 9 with its piston 21 is moved in direction of the housing 1 and the battery system 3 received therein. The piston 21 compresses the spring element 20 in the cylinder 22 to the extent, where the contacting device 9 can pass through the housing 1 and electrically connect the contact connections 5, 6 of the battery system 3 in order to cause a discharge current to flow. The spring element 20 may be additionally configured to be lockable in the compressed position in the piston cylinder 22. The embodiments are not limited to the coupling device shown.

Or, if a coupling device is not provided, the housing 1 with the at least one battery cell 2 received therein may be arranged together with the contacting device 9 such, that in case of a frontal crash, a rear crash and/or a lateral crash of the vehicle 18, the housing and/or the contacting device 9 are moved towards each other in such a way that the contact elements 10 of the contacting device 9 are electrically connected with the contact connections 5, 6 of the battery cell 2 in order to cause a discharge current to flow.

Additionally a triggering device 24 may be provided which, in case an imminent accident being detected and/or in case of an occurred accident, moves the contacting device 9 such that the contact elements 10 of the contacting device 9 electrically contact the at least one positive contact connection 5 or the at least one negative contact connection 6 of a battery cell 2 arranged in the battery-holding space 7 of the housing 1. The triggering device 24 may comprise a motor 25 which can be controlled by a control unit such as control unit 26 of the vehicle, for example on the basis of an airbag signal. In case of an accident, the motor 25 of the triggering device 24 moves the contacting device 9, for example, through the contacting area 8 of the housing 1 to the contact connections 5, 6 of battery cell 2 such that the contacting device 9 is electrically connected with the contact connections 5, 6 causing a discharge current to flow. The triggering device 24 may be provided additionally or alternatively to the coupling device.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A housing for holding a vehicle battery cell, comprising:
a battery holding space for receiving a battery cell; and
a contacting area at a location for the vehicle battery cell and arranged in the battery holding space for a first contact connection and a second contact connection for the vehicle battery cell; and
wherein the contacting area is configured such that when the contacting area is actuated with a contacting device, an electrical contact through the housing is established between the first contact connection and the second contact connection of the vehicle battery cell.

2. The housing according to claim 1,
wherein the contacting area comprises at least two predetermined breaking points (12),
wherein each of the at least two predetermined breaking points is a arranged on the housing in the location.

3. The housing according to claim 1, wherein the contacting area comprises at least two repeatedly mechanically operable contact arranging units.

4. The housing according to claim 1, further comprising a contact arranging unit that comprise a mechanical guide that is configured to guide the contacting device for actuating the contacting area.

5. The housing according to claim 4, wherein the at least predetermined breaking points and the contact arranging unit comprise a one locking device that is configured to protect the contacting area against actuation when in a non-actuated state and to permit actuation of the contacting area when in an actuated state.

6. The housing according to claim 1, the contacting device comprising:
that are configured to electrically contact a positive contact connection and a negative contact connection of the battery cell arranged in the battery holding space of the housing,
wherein the at least two contact elements are configured to electrically contact the contact positive contact connection and the negative contact connection through the contacting area of the housing.

7. The housing according to claim 6, wherein the contacting device is composed of an electrically resistive material.

8. The housing according to claim 6, wherein the at least two contact elements of the contacting device are formed as metallic contact elements that are connected via a connecting element.

9. The housing according to claim 8, wherein the connecting element comprises an electrically insulated gripping surface.

10. The housing according to claim 6, characterized in that the contacting device is a U-shape and in that the at least two contact elements are arranged at one end of the U-shape.

11. (canceled)

12. (canceled)

13. (canceled)

14. (canceled)

15. (canceled)
